(19) United States
(12) Patent Application Publication
(10) Pub. No.: US 2023/0370177 A1
(43) Pub. Date: Nov. 16, 2023

(54) WIRELESS TELECOMMUNICATION SYSTEM

(71) Applicant: BRITISH TELECOMMUNICATIONS PUBLIC LIMITED COMPANY, London (GB)

(72) Inventors: Anvar TUKMANOV, London (GB); Arman SHOJAEIFARD, London (GB)

(21) Appl. No.: 18/044,440

(22) PCT Filed: Aug. 10, 2021
(86) PCT No.: PCT/EP2021/072218

§ 371 Date: Mar. 8, 2023

(30) Foreign Application Priority Data
Sep. 9, 2020 (GB) 2014186.7

(51) Int. Cl. H04B 17/20; H04L 43/0823; H04L 43/0876; H04B 7/06

(52) U.S. Cl. CPC H04B 17/201; H04L 43/0847; H04L 43/0876; H04B 7/0608

(57) ABSTRACT

A method and a controller for controlling a transmitting node in a wireless telecommunications network, the wireless telecommunications network including a receiving node, wherein the transmitting node includes a plurality of antenna ports, the method including determining a count of antenna ports, being one or more of the transmitting node's plurality of antenna ports, to use in communications with the receiving node based on: a balance between a first performance metric related to a coherence interval and having a positive relationship with the count of antenna ports and a second performance metric related to the coherence interval and having a negative relationship with the count of antenna ports, and/or a measure of the coherence interval in communications with the receiving node; and causing the transmitting node to use the count of antenna ports in communications with the receiving node.

### PRIORITY CLAIM

The present application is a National Phase entry of PCT Application No. PCT/EP2021/072218, filed Aug. 10, 2021, which claims priority from GB Patent Application No. 2014186.7, filed Sep. 9, 2020, each of which is hereby fully incorporated herein by reference.

### TECHNICAL FIELD

The present disclosure relates to a wireless telecommunication system.

### BACKGROUND

Channel Estimation (CE) is a process for estimating properties of a channel of a wireless communications link. This information is often referred to as the Channel State Information (CSI) and describes how a signal propagates between a transmitter and receiver. The CSI is particularly important in wireless telecommunication systems employing multiple antennas (e.g. Multiple-Input and Multiple-Output (MIMO) and Massive-MIMO) so that the transmissions may be adapted to channel conditions.

Methods for CE include channel reporting and channel measurement. In channel reporting, a first node transmits a signal to a second node, and the second node performs measurements on the signal (e.g. of embedded reference signals) and subsequently reports these measurements to the first node. The first node may then determine the CSI for transmissions from the first node to the second node based on these measurements. In channel measurement, the first node receives a signal from the second node and performs measurements on the signal (e.g. of embedded reference signals). Although these measurements are directly related to the CSI for transmissions from the second node to the first node, the first node may determine the CSI for transmissions from the first node to the second node based on these measurements by assuming an identical state for transmission from the first node to the second node (known as channel reciprocity).

Following CE, the CSI may be used to adapt transmissions between the first and second nodes. However, as the properties of a channel may change over time, there may be a difference between the channel as represented by the CSI and the actual channel at the time of reception of a transmission. The magnitude of this difference may result in poor Quality of Service (QoS) at the receiver (e.g. high error values). This difference may be quantified in terms of a coherence interval, which indicates a span of subcarriers in the frequency domain and symbols in the time domain over which the CSI remains sufficiently accurate for data communication to operate effectively (relative to some threshold). After this point, the channel is said to “decorrelate” and a further CE is required to determine the new CSI. Smaller coherence intervals may therefore result in increased control signaling (for channel reporting based CE) and increased processing (for both channel reporting based CE and channel measurement based CE).

### SUMMARY

According to a first aspect of the disclosure, there is provided a method of controlling a transmitting node in a wireless telecommunications network, the wireless telecommunications network including a receiving node, wherein the transmitting node includes a plurality of antenna ports, the method comprising determining a count of antenna ports, being one or more of the transmitting node's plurality of antenna ports, to use in communications with the receiving node based on: a balance between a first performance metric related to a coherence interval and having a positive relationship with the count of antenna ports and a second performance metric related to the coherence interval and having a negative relationship with the count of antenna ports, and/or a measure of the coherence interval in communications with the receiving node; and causing the transmitting node to use the count of antenna ports in communications with the receiving node.

The measure of the coherence interval may be a relative speed between the transmitting node and receiving node.

The first performance metric may be one of a first set of performance metrics based on one or more of the following: a data rate for the communications with the receiving node, and an error rate for the communications with the receiving node.

The second performance metric may be one of a second set of performance metrics based on one or more of the following: a power consumption profile of the transmitting node, a power consumption profile of the receiving node, and an indicator of control signaling load.

Causing the transmitting node to use the count of antenna ports may be implemented by iteratively adjusting an interim count of antenna ports in communications with the receiving node until a termination condition is satisfied, wherein the termination condition may be based on the first performance metric related to the coherence interval.

The wireless telecommunications network may be a cellular telecommunications network.

According to a second aspect of the disclosure, there is provided a computer program comprising instructions which, when the program is executed by a computer, cause the computer to carry out the method of the first aspect of the disclosure. The computer program may be provided on a computer readable carrier medium.

According to a third aspect of the disclosure, there is provided a controller for a wireless telecommunications network, the wireless telecommunications network including a transmitting node and a receiving node and the transmitting node includes a plurality of antenna ports, the controller comprising a processor adapted to carry out the method of the first aspect of the disclosure.

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of an embodiment of a wireless telecommunications system of the present disclosure.

FIG. 2 is a schematic diagram of a base station and a first user equipment of the system of FIG. 1.

FIG. 3 is a flow diagram of an embodiment of a method of the present disclosure.

### DETAILED DESCRIPTION

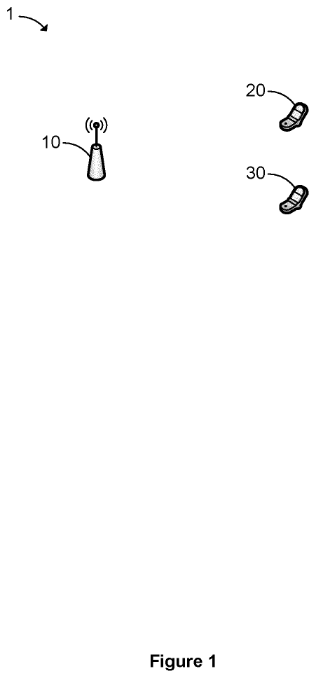

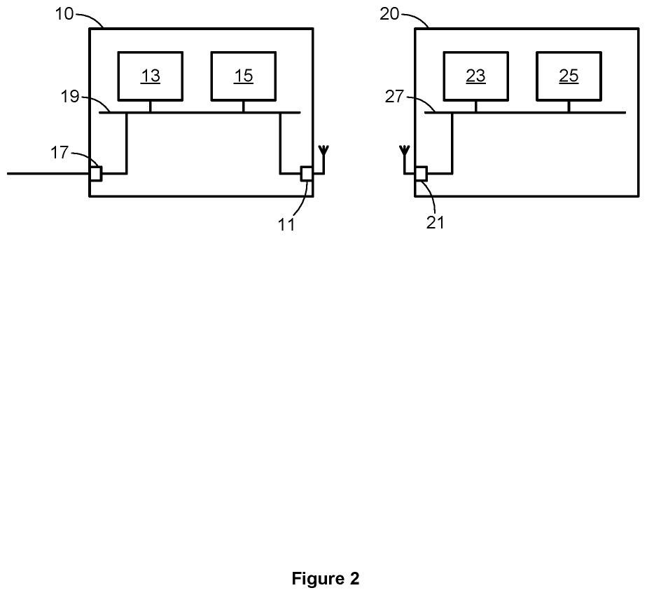

A first embodiment of a wireless telecommunication system 1 of the present disclosure will now be described with reference to FIGS. 1 to 2. In this embodiment, the wireless telecommunication system 1 is a cellular telecommunications system including a base station 10, a first User Equipment (UE) 20 and a second UE 30.

The base station 10 and first UE 20 are shown in more detail in FIG. 2. The base station 10 includes a first communications interface 11 (connected to an antenna for wireless communications with the first and second UE 20, 30), a processor 13, memory 15, and a second communications interface 17 (connected to a backhaul network via optical fiber), all connected via bus 19. In this embodiment, the first communications interface 11 is connected to an antenna array with 64 antenna ports, and the processor 13 includes 64 transmitter-receiver chains (otherwise known as RF chains), each associated with a particular antenna port of the antenna array. Processor 13 may control the first communications interface 11 to communicate with UE via a subset or all of these antenna ports (such that the antenna ports act cooperatively to communicate with the UE). The first UE 20 includes a first communications interface 21 (connected to an antenna port for wireless communications with the base station 10), a processor 23, and memory 25, all connected via bus 27. The second UE 30 is substantially the same as the first UE 20. The base station 10, first UE 20 and second UE 30 operate according to the 5^{th} Generation (5G) cellular telecommunications protocol, as standardized by the 3^{rd} Generation Partnership Project (3GPP).

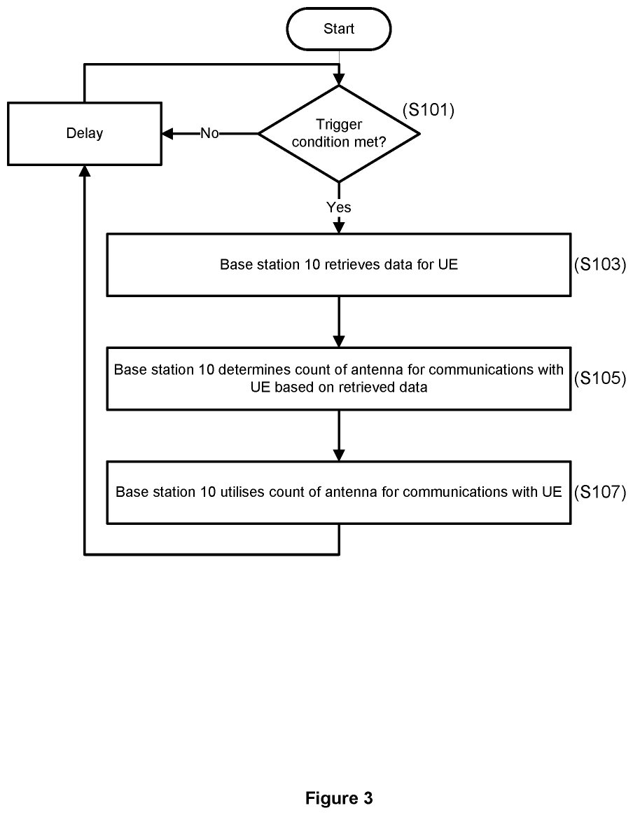

An embodiment of a method of the present disclosure will now be described with reference to FIG. 3. This embodiment relates to downlink communications from the base station 10 to the first UE 20 and second UE 30. In S101, the base station 10 determines whether a trigger condition is satisfied. This trigger condition may be, for example, the base station 10 receiving an attach request from a UE, a period of time elapsing from a previous iteration of the method, or communications between the base station 10 and a UE not satisfying a quality threshold. In this embodiment, the trigger condition is satisfied for both the first and second UE 20, 30 following receipt of attach requests from both the first and second UE 20, 30.

In S103, the base station 10 retrieves data for the first UE 20 and data for the second UE 30. In this embodiment, this data includes:
One or more Quality of Service (QoS) requirements for each UE, such as a minimum data rate requirement and a maximum error rate requirement;
An indicator of each UE's mobility (i.e. speed) relative to the base station. In this embodiment, each UE's mobility is obtained from a UE location service;
A count of supported spatial multiplexing layers for each UE. In this embodiment, this count is part of each UE's capabilities indication;
A direction between the base station and each UE. In this embodiment, this is determined by a digital signal processing algorithm, such as multiple signal classification;
Each UE's power consumption profile (e.g. an indicator that the UE has entered a low power consumption state due to limited battery/power resources); and
An indicator of channel quality between the base station 10 and each UE, such as Signal to Noise plus Interference Ratio (SNIR), Reference Signal Received Power (RSRP), error rate, and/or path loss.

This data was previously sent to, or measured by, the base station 10 (e.g. during an attach procedure), and stored in memory 15. The base station 10 may also retrieve (e.g. from memory 15) data that is not specific to the UE but may be used in S105 below. This may include, for example, the base station's current radio resource utilization.

In S105, the base station 10 determines a first optimum count of antenna ports to use in downlink communications with the first UE 20 and a second optimum count of antenna ports to use in downlink communications with the second UE 30. In a general sense, the optimum count of antenna ports to use in downlink communications is calculated as a balance of several performance metrics that are impacted by a changing coherence interval. The present inventors have realized that there is an inverse (i.e. negative) relationship between the count of antenna ports used in a communication from a first node to a second node and the coherence interval of that communication (such that the coherence interval increases as the count of antenna ports is lowered and vice versa). Furthermore, some UE data is indicative of a changing coherence interval, such as UE speed in which relatively fast UE generally experience changing channel conditions and therefore a shorter coherence interval. Accordingly, the data retrieved in S101 can be analyzed to identify changes to the coherence interval due to variable channel conditions (e.g. due to the UE's speed) and the optimum count of antenna ports may be calculated so as to mitigate against any negative impact on performance metrics that are caused by these changes. Furthermore, the optimum count of antennas may be calculated as a balance between performance metrics which are negatively impacted as the coherence interval is decreased and performance metrics which are negatively impacted as the coherence interval is increased, based on the operator's preferences for these performance metrics (which may also take into account the identified changes to the coherence interval due to variable channel conditions). In this embodiment, the logic is based on the following factors:
The data rate for downlink communications to the UE will be negatively impacted as the count of antenna ports is lowered so as to increase the coherence interval. Furthermore, a minimum data rate requirement for the UE indicates a minimum count of antenna ports required in downlink communications to the UE (this may be calculated based on the indicator of the channel quality between the first base station 10 and UE);
The error rate for downlink communications to the UE may be negatively impacted as the count of antenna ports is lowered so as to increase the coherence interval. Furthermore, a maximum error rate requirement for the UE indicates a minimum count of antenna ports required in downlink communications to the UE (this may also be calculated based on the indicator of the channel quality between the first base station 10 and UE);
The UE's mobility influences the calculation so that relatively fast UE use a lower count of antenna ports and vice versa. As relatively fast UE are more likely to be subject to variable channel conditions which typically leads to a reduction in the coherence interval, then implementing a lower count of antenna ports will mitigate against any negative impacts on performance metrics that would otherwise have occurred;
The count of supported spatial multiplexing layers indicates a minimum count of antenna ports required in downlink communications to the UE (that is, the count of antenna ports must be at least equal to the count of supported spatial multiplexing layers);
The direction to the UE also indicates a minimum count of antenna ports required in downlink communications to the UE (that is, if the base station 10 needs to implement beam-steering to cover a UE, the minimum count of antenna ports must be at least equal to that required to implement the beam-steering);
UE power consumption may be positively impacted as the count of antenna ports is lowered so as to increase the coherence interval. This positive impact is due to the UE being required to participate in CE operations less frequently as the coherence interval is increased, reducing the corresponding power consumption. Accordingly, a UE in a low power consumption state may use a lower count of antenna ports (relative to a UE that is not in a low power consumption state); and
The control feedback overhead may be positively impacted as the count of antenna is lowered which increases the coherence interval. This positive impact is due to the UE and base station performing CE operations less frequently as the coherence interval is increased and further having fewer antenna ports to report CSI on, reducing the corresponding amount of control signaling. Accordingly, a base station in a state where its control feedback signaling overhead is too high (e.g. above a threshold) may use a lower count of antenna ports (relative to a base station that is in a state where its control feedback signaling overhead is less than the threshold).

These factors may be members of one or more of the following sets:
A first set of factors that are individually or collectively indicative of relatively variable channel conditions (and therefore a shortening coherence interval), such as UE speed above a certain threshold;
A second set of factors that are individually or collectively indicative of relatively stable channel conditions (and therefore a lengthening coherence interval), such as UE speed below a certain threshold;
A third set of factors that are individually or collectively indicative of performance metrics that have a positive relationship with a count of antenna ports used in the downlink communication (i.e. the performance metric improves as the count of antenna ports increases), such as data rate and error rate;
A fourth set of factors that are individually or collectively indicative of performance metrics that have a negative relationship with a count of antenna ports used in the downlink communication (i.e. the performance metric deteriorates as the count of antenna ports increases), such as control signaling load and UE and/or base station power consumption; and
A fifth set of factors that are individually or collectively indicative of a performance metric that defines a minimum count of antenna ports to be used in the downlink communication, such as a minimum data rate and maximum error rate.

In this embodiment, the calculation logic utilizes one or more factors from the fifth set of factors that define a minimum count of antenna ports to be used in the downlink communication. The calculation logic may therefore determine an overall minimum count of antenna ports that should be used based on the maximum of these minima (i.e. if the minimum count of antenna ports to support the minimum data rate requirement is 8 and the minimum count of antenna ports to implement beam-steering to the UE is 16, then the overall minimum count of antenna ports would be 16).

The operator may then determine an optimum count of antenna ports between this overall minimum count of antenna ports and the total number of antenna ports in the antenna array based on one or more of the other example factors above (from one or more of the first set to fourth set of factors) and the operator's desired weighting.

Furthermore, these factors are merely examples, and other factors may be used (alternatively or additionally).

In this embodiment, the base station 10 determines that communications from the base station 10 to the first UE 20 should use 64 antenna ports (i.e. all antenna ports of the antenna array) as the calculation logic is configured such that the positive impact of a longer coherence interval of any magnitude on some performance metrics (e.g. power consumption or control signaling overhead) does not outweigh the negative impacts of the lowered count of antenna ports on other performance metrics (e.g. on data rate). Furthermore, the base station 10 determines that communications from the base station to the second UE 30 should use 32 antenna ports as the calculation logic is configured such that the positive impact of a longer coherence interval on some performance metrics does outweigh the negative impact of the lower count of antenna ports on other performance metrics, and that the particular weightings of the calculation logic determined that the coherence interval of 32 antenna ports was a suitable balance between these positively impacted performance metrics and negatively impacted performance metrics.

In S107, the base station 10 configures its processor 13 and first communications interface 11 so that future communications to the first UE 20 use 64 antenna ports and so that future communications to the second UE 30 use 32 antenna ports.

The process then loops back to S101 for further iterations, so that the method may respond to any changing conditions in the communications link.

By configuring the count of antenna ports for communications from the base station 10 to the first UE 20 and second UE 30 to use 64 and 32 antenna ports respectively, subsequent communications to the second UE 30 will have a relatively long coherence interval compared to the coherence interval of communications to the first UE 20. This means that the channel conditions of the communications link between the base station and the second UE 30 are sufficiently stable over a relatively long time period to support communications of a desired quality (relative to application-specific thresholds). This reduces the number of CE operations that must be performed by the base station 10 and/or second UE 30 (depending on the particular CE method in use), which, as noted above, was determined by the calculation logic of S103 to be appropriate for the likely positive and negative impacts of the lowered count of antenna ports and longer coherence interval on the various performance metrics when using 32 antenna ports.

In the above embodiment, the base station 10 uses a targeted approach to calculate the appropriate count of antenna ports to use for each UE based on data for each UE. This targeted approach may be based on a calibration phase in which the operator's calculation logic (based on one or more of the above factors each having an adjustable weighting) may be determined based on multiple real-world and/or simulated examples. Furthermore, the use of a targeted approach is non-essential as the base station 10 may iteratively adjust the count of antenna ports by a predetermined amount (e.g. 1, 2, 4, 8 antenna ports) until a termination condition related to the coherence interval is met. The termination condition may be that positive impact on one or more performance metrics related to the coherence interval caused by the adjustment satisfies a threshold (e.g. the UE power consumption dropping below a threshold when the count of antenna ports is reduced so as to increase the coherence interval and reduce the frequency of CE operations). Alternatively, the termination condition may be that the negative impact on one or more performance metrics related to the coherence interval caused by the adjustment satisfies a threshold (e.g. the data rate decreasing below a threshold due to a lowering of the count of antenna ports), such that the current coherence interval is optimized for the current conditions.

The above embodiment is based upon downlink communications between a base station and UE. However, this is non-essential as the above embodiment may be implemented in any wireless communications link in which the transmitting node has a plurality of antenna ports. For example, uplink communications of a UE to a base station may also utilize the method if the UE has multiple antenna ports. Furthermore, the disclosure is not limited to cellular telecommunications networks, as many other forms of wireless telecommunications networks (such as wireless local area networks or wireless wide area networks) may also include transmitting nodes with multiple antenna ports.

The skilled person will also understand that it is non-essential for the base station to perform the above process. That is, another entity (such as a centralized controller of a wireless communications network) could implement the process and inform the transmitting node of the count of antenna ports to use in communications with the receiving node.

The skilled person will understand that any combination of features is possible within the scope of the disclosure, as claimed.

1. A method of controlling a transmitting node in a wireless telecommunications network, the wireless telecommunications network including a receiving node, wherein the transmitting node includes a plurality of antenna ports, the method comprising the steps of:
determining a count of antenna ports, being one or more of the transmitting node's plurality of antenna ports, to use in communications with the receiving node based on:
a balance between a first performance metric related to a coherence interval and having a positive relationship with the count of antenna ports and a second performance metric related to the coherence interval and having a negative relationship with the count of antenna ports, and/or
a measure of the coherence interval in communications with the receiving node; and
causing the transmitting node to use the count of antenna ports in communications with the receiving node.

2. A method as claimed in claim 2, wherein the measure of the coherence interval is a relative speed between the transmitting node and receiving node.

3. A method as claimed in claim 1 or claim 2, wherein the first performance metric is one of a first set of performance metrics based on one or more of the following:
a data rate for communications with the receiving node, and
an error rate for communications with the receiving node.

4. A method as claimed in any one of the preceding claims, wherein the second performance metric is one of a second set of performance metrics based on one or more of the following:
a power consumption profile of the transmitting node,
a power consumption profile of the receiving node, and
an indicator of control signalling load.

5. A method as claimed in any one of the preceding claims, wherein the step of causing the transmitting node to use the count of antenna ports is implemented by iteratively adjusting an interim count of antenna ports in communications with the receiving node until a termination condition is satisfied, wherein the termination condition is based on the first performance metric related to the coherence interval.

6. A method as claimed in any one of the preceding claims, wherein the wireless telecommunications network is a cellular telecommunications network.

7. A computer program comprising instructions which, when the program is executed by a computer, cause the computer to carry out the steps of any one of the preceding claims.

8. A computer readable carrier medium comprising the computer program of claim 7.

9. A controller for a wireless telecommunications network, the wireless telecommunications network including a transmitting node and a receiving node and the transmitting node includes a plurality of antenna ports, the controller comprising a processor adapted to carry out the steps of any one of claims 1 to 6.
